(19) United States
(12) Patent Application Publication
(10) Pub. No.: US 2019/0087901 A1
(43) Pub. Date: Mar. 21, 2019

(54) Risk Flow-Through Account Process

(71) Applicant: Michael Taillard, Beulah, MI (US)

(72) Inventor: Michael Taillard, Beulah, MI (US)

(21) Appl. No.: 15/711,966

(22) Filed: Sep. 21, 2017

(51) Int. Cl. G06Q 40/08; G06F 15/18

(52) U.S. Cl. CPC G06Q 40/08; G06F 15/18

(57) ABSTRACT

The Risk Pass-Through Account Process utilizes a set of unique algorithms to establish a unique business process by which account customers generate interest on their risk, rather than their investments, overcoming flaws in the existing business processes available for mitigating financial risk, which represent a risk to consumers in that they may incur losses on their decision to invest in the mitigation of risks which never come to pass or which are not included in the parameters of the product.

### BACKGROUND OF THE INVENTION

The present invention relates to business processes for financial risk products.

Financial risk products are intended to be used by consumers and investors for the purpose of limiting the potential for financial losses. In many states, particular type of financial risk products are mandatory, such as automobile insurance for drivers, while other products like annuities are not. All products for mitigating financial risk utilize processes which are typical within the financial industry. These include the use of underwriters to assess risk cost, and the retained ownership of risk-generated earnings by the business. Financial institutions have been able to statistically establish with great accuracy the risk associated with individual clients, and provide products which do not properly represent the mitigation of that risk. To the contrary, these risk mitigation products, themselves, contain risks of financial loss resulting from both a cost which exceeds the value of the product to the individual, and the systematic mismatching of risks to which customers are exposed, and the risks being mitigated by the promise of faulty financial products.

The invention utilizes a custom-developed business process never before seen in the financial industry. In order to successfully develop this process, custom-developed equations had to be invented, and a custom-developed artificial intelligence based on machine learning algorithms had to be invented. The process is being claimed within the patent, as are the equations and the artificial intelligence algorithm.

### BRIEF SUMMARY OF THE INVENTION

The result of this invention is a business process by which risk cost analysis is continuously improved and are not subject to errors in human judgment through the use of adaptive analytics methods made possible via artificial intelligence, and the generation of risk-based interest income owned by the customers and paid to them using econometric analysis of the individual customer's contributions to risk and value. This process allows for the introduction of a superior product in which customer risk is mitigated, while eliminating the risk of the risk mitigation product, itself.

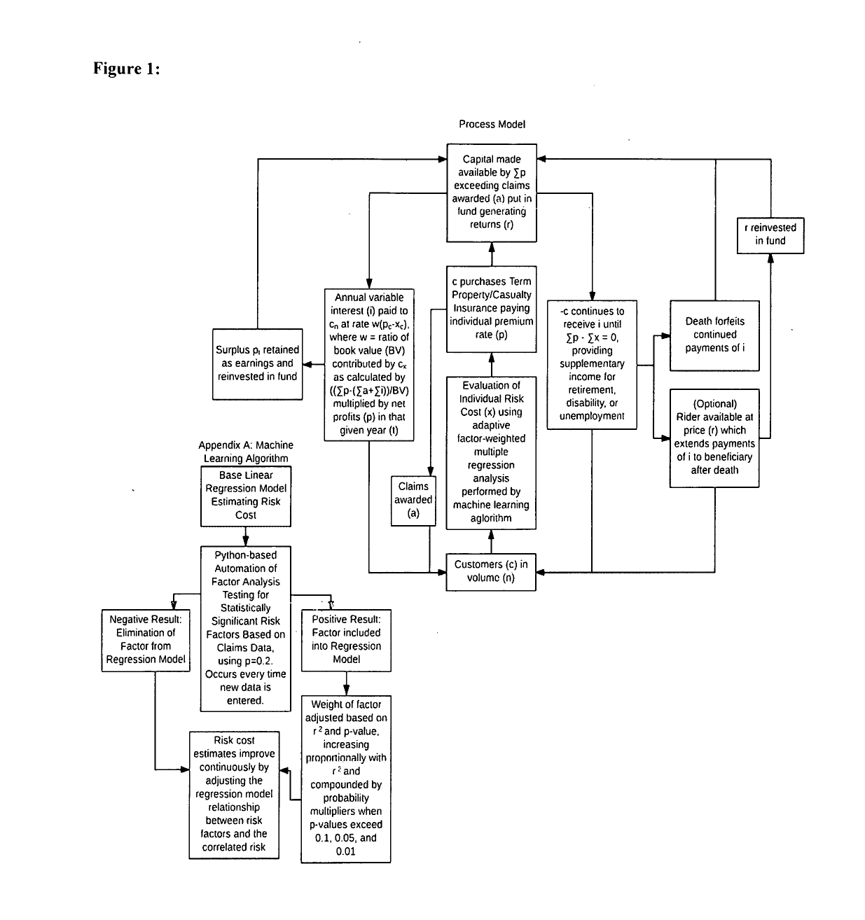

### BRIEF DESCRIPTION OF FIG. 1

FIG. 1 illustrates 3 vital elements:
1) The unique process by which account owners generate income through the ownership of productions for the mitigation of financial risk, allowing for the elimination of the risk inherent in existing financial risk products.
2) The unique equations used to measure risk-based variable interest income generated by account owners, and optionally their beneficiaries.
3) The unique artificial intelligence algorithm developed for the purpose of assessing risk-cost of account applicants.

### DETAILED DESCRIPTION OF THE INVENTION

The invention is a business process, which incorporates several custom-designed elements. The process begins with engagement by a customer seeking products for financial risk mitigation. They are individually evaluated for the risk cost, which is the probability of the individual filing a claim multiplied by the likely value of the claim. This is performed not by underwriters, but by a custom-designed artificial intelligence based on a machine learning algorithm that improves its estimates with each new data point provided. This is done by performing statistical significance testing for factors based on a p value of 0.2, and including any statistically significant factors into a weighted multiple regression that calculates risk cost. As new data points are provided, the artificial intelligence will automatically adapt its estimates of cost risk.

Once evaluated for cost risk, the customer is given partial ownership of the company by means of a financial account, the value of which determines the amount of ownership in the earnings of the company's investing activities as a weighted ratio of the company's total value relative to the amount that the customer has contributed measured using the difference in premiums paid and cost risk, minus any claims which have been made. The customer must make regular deposits into their account to maintain ownership status. Missed payments will result in immediate termination of risk mitigation coverage for property and casualty losses, and put them into a state of receiving diminishing interest payments. A new account will need to be opened in order to resume coverage for risk mitigation of casualty and property losses.

All deposits made in excess of claims awarded are put into a low-risk diversified investment portfolio. The total earnings generated are owned by the account owners and is repaid to the account owners in an amount equivalent to a ratio of their weighted contributions to book value of the company made through deposits made in excess of risk-cost minus any claims awarded. These payments mitigate against the risks of financial loss resulting from both a cost which exceeds the value of the product to the individual, and the systematic mismatching of risks to which customers are exposed, and the risks being mitigated by the promise of faulty financial products. The surplus earnings are retained in the investment portfolio to generate continued earnings for the account owners.

Should an account owner miss a deposit or otherwise forfeit their account, they will lose financial risk protection against casualty and property losses, but will continue to receive interest payments. These interest payments function to mitigate risk of loss of income, long-term medical expenses, retirement, and so forth. The amount of these payments will diminish over time as the total account value in excess of total risk cost decreases. Should the account owner die, they no longer incur any risk, and so their account is forfeit. An optional process available is to include a beneficiary on the account, who would also have to go through the risk cost assessment process to determine the additional monthly deposits which must be made into the account in order to maintain risk protection for the beneficiary in terms of continued interest payments that otherwise would have been owed to the account owner.

All equations and algorithms are included in FIG. 1.

Items being claimed:

1) The unique custom artificial intelligence algorithm used to develop continuously-adaptive regression models of cost-risk.

2) Dependent upon claim 1, the pass-through ownership of risk earnings in excess of cost risk by account holders.

3) The calculations of variable risk-based interest described in FIG. 1.

4) Dependent upon claim 3, the pass-through to account owners of risk-based earnings generated.

5) The calculation of diminishing risk-based interest income to ex-account holders as described in FIG. 1.

6) Dependent on claim 5, the continued diminishing pass-through of risk-based interest income to ex-account holders, and optionally their beneficiary, as illustrated in FIG. 1.

7) Dependent on claim 2, the investment of risk earnings owned by account holders into an independently managed fund.
